(19) United States
(12) Patent Application Publication
(10) Pub. No.: US 2025/0286373 A1
(43) Pub. Date: Sep. 11, 2025

(54) PLANNED POWER SYSTEM OPERATION DEVICE AND PLANNED POWER SYSTEM OPERATION METHOD

(71) Applicant: HITACHI, LTD., Tokyo (JP)

(72) Inventors: Takahisa MATSUZAKI, Tokyo (JP); Yohei MURAKAMI, Tokyo (JP); Masaya SENDA, Tokyo (JP); Masahiro WATANABE, Tokyo (JP); Shinya OHARA, Tokyo (JP); Tohru YOSHIHARA, Tokyo (JP); Ruriko HARAGUCHI, Tokyo (JP); Hiroko SUKEDA, Tokyo (JP); Robert Joseph ELLIS, Tokyo (JP); Yuta TSUCHIYA, Tokyo (JP)

(21) Appl. No.: 18/860,074

(22) PCT Filed: Apr. 26, 2023
(86) PCT No.: PCT/JP2023/016462

§ 371 Date: Oct. 25, 2024

(30) Foreign Application Priority Data
May 11, 2022 (JP) 2022-078134

(51) Int. Cl. H02J 3/00; G06Q 50/06; H02J 13/00

(52) U.S. Cl. CPC H02J 3/0012; G06Q 50/06; H02J 3/00125; H02J 13/00002; H02J 2203/10; H02J 2203/20

(57) ABSTRACT

A planned power system operation device includes: a typhoon countermeasures candidate calculation unit that obtains typhoon countermeasures candidate calculation result data including a change value of an output of a power station for each typhoon countermeasures case from typhoon information data including at least course information and wind speed of a typhoon and system operation countermeasures candidate data including output information of a power station; a reliability economy index value calculation unit that obtains reliability economy index value calculation result data, which is an index value of reliability economy, from the typhoon countermeasures candidate calculation result data, system data indicating a system configuration, damage cost data associated with a power outage, and reliability economy index data indicating a weight on an influence of a power outage; and a typhoon countermeasures determination unit that obtains typhoon countermeasures determination result data from the reliability economy index value calculation result data.

### TECHNICAL FIELD

The present invention relates to a planned power system operation device and a planned power system operation method.

### BACKGROUND ART

A power system has equipment formation and operation such that system stability (synchronous stability, voltage stability, frequency stability, overload, and the like) is maintained even when a single failure occurs, and a power outage is not caused. Hereinafter, this is called an N−1 contingency.

When a natural disaster such as a typhoon, an earthquake, or a lightning strike occurs, a plurality of failures may occur simultaneously or continuously, and a multiple failure (an accident of N−1 contingency or more) may occur. For a multiple failure, a social influence (social loss due to power outage) due to the occurrence of the failure increases. In recent years, due to severe typhoons caused by climate change, maintenance of power supply during typhoons has become a problem, and countermeasures such as enhancement of system equipment and facilities such as transmission towers have been required.

For example, PTL 1 describes a system for supporting prediction of damage caused by a typhoon including: climate-data observatory instruments arranged in places on power distribution lines and actually measuring climate data; a management server which is connected to these climate-data observatory instruments via a remote-controllable transmission line network and receives the climate data actually measured; and a damage history database which records the histories of past damage details together with damage locations and climate conditions at the time. The management server includes: a damage prediction target region setting means which sets a damage prediction target region; a typhoon information acquisition means which acquires typhoon information from a typhoon information transmission source; a weather condition prediction means which predicts a weather condition for each time at each damage prediction target coordinate in the set damage prediction target region in consideration of typhoon information acquired by the typhoon information acquisition means and weather data actually measured by the climate-data observatory instruments; a damage details prediction means which predicts damage details at each damage prediction target coordinate based on the damage history database from a weather condition predicted at the damage prediction target coordinate; and a damage details recording means which records the damage details having been predicted.

### CITATION LIST

### Patent Literature

PTL 1: JP 2010-049433 A

### SUMMARY OF INVENTION

### Technical Problem

In the technique of PTL 1, both prediction of a typhoon and actual measurement data at each damage prediction point are recorded when typhoon damage occurs. Due to this, even in a case of a damage of an overhead line due to a typhoon or the like, the damage prediction database records the damage prediction rate together with the predicted damage details, therefore it is possible to provide information on the damage prediction of the damage prediction target coordinate together with the occurrence rate, and it is possible to confirm credibility of the damage that is predicted. Then, it is possible to make a response after accident based on the damage prediction.

In the technique of PTL 1, by making an appropriate response after the accident, it is possible to reduce a damage after the damage caused by a typhoon, but it is not possible to take countermeasures before an accident by the typhoon and a power outage associated therewith occur.

An object of the present invention is to provide a planned power system operation device and a planned power system operation method that can reduce a social cost such as damage of an overhead line due to a typhoon and to improve resilience even before an accident by the typhoon and a power outage associated therewith occur.

### Solution to Problem

In order to solve the above problems, a planned power system operation device of the present invention includes: a typhoon countermeasures candidate calculation unit that obtains typhoon countermeasures candidate calculation result data including a change value of an output of a power station for each typhoon countermeasures case from typhoon information data including at least course information and wind speed of a typhoon and system operation countermeasures candidate data including output information of a power station; a reliability economy index value calculation unit that obtains reliability economy index value calculation result data, which is an index value of reliability economy, from the typhoon countermeasures candidate calculation result data, system data indicating a system configuration, damage cost data associated with a power outage, and reliability economy index data indicating a weight on an influence of a power outage; and a typhoon countermeasures determination unit that obtains typhoon countermeasures determination result data from the reliability economy index value calculation result data.

### Advantageous Effects of Invention

According to the present invention, it is possible to achieve reduction of a social cost of a power system due to a typhoon and improvement of resilience of the power system.

### BRIEF DESCRIPTION OF DRAWINGS

FIG. 1 is a view illustrating a relationship between a power system diagram when a typhoon is approaching and a projected course of the typhoon.

FIG. 2 is a view illustrating a functional configuration of a planned power system operation device of Example 1.

FIG. 3 is a view illustrating a planned power system operation system applied with the planned power system operation device of Example 1.

FIG. 4 is a view describing a hardware configuration of the planned power system operation device of Example 1.

FIG. 5 is a view illustrating a configuration of a typhoon countermeasures calculation program.

FIG. 6 is a view illustrating a configuration of typhoon information data in a typhoon countermeasures calculation input data DB.

FIG. 7 is a view illustrating that an occurrence rate is represented by a probability distribution function of a collapse rate with respect to wind speed of a tower.

FIG. 8 is a view illustrating a configuration of system operation countermeasures candidate data in the typhoon countermeasures calculation input data DB.

FIG. 9 is a view illustrating a configuration of damage cost data in the typhoon countermeasures calculation input data DB.

FIG. 10 is a view illustrating a configuration of reliability economy index data in the typhoon countermeasures calculation input data DB.

FIG. 11 is a view illustrating a configuration of typhoon countermeasures candidate calculation result data in a typhoon countermeasures calculation result data DB.

FIG. 12 is a view illustrating a configuration of reliability economy index value calculation result data in the typhoon countermeasures calculation result data DB.

FIG. 13 is a view illustrating a configuration of typhoon countermeasures determination result data in the typhoon countermeasures calculation result data DB.

FIG. 14 is a view describing a processing flow of a typhoon countermeasures calculation unit of the planned power system operation device.

FIG. 15 is a view illustrating a display example that a display control unit outputs to a display unit.

FIG. 16 is a view illustrating another display example that the display control unit outputs to the display unit.

FIG. 17 is a view illustrating a functional configuration of a planned power system operation device in Example 2 and a functional configuration of an energy management system.

FIG. 18 is a view illustrating the planned power system operation system of Example 2 applied with the planned power system operation device and the energy management system described in FIG. 17.

FIG. 19 is a view illustrating a functional configuration of a planned power system operation device in Example 3.

FIG. 20A is a view illustrating a configuration of system maintenance countermeasures candidate data in a case where a system maintenance countermeasures type is transmission line expansion.

FIG. 20B is a view illustrating a configuration of system maintenance countermeasures candidate data in a case where a system maintenance countermeasures type is substation expansion.

FIG. 20C is a view illustrating a configuration of system maintenance countermeasures candidate data in a case where a system maintenance countermeasures type is phase modification equipment expansion.

FIG. 21A is a view describing typhoon countermeasures candidate calculation result data stored for each typhoon countermeasures case and storing information on system maintenance countermeasures and system operation countermeasures.

FIG. 21B is a view describing other typhoon countermeasures candidate calculation result data stored for each typhoon countermeasures case and storing information on system maintenance countermeasures and system operation countermeasures.

FIG. 22 is a view illustrating a hardware configuration of a planned power system operation device of Example 3.

FIG. 23 is a view illustrating a functional configuration of a planned power system operation device in Example 4 and a functional configuration of an energy management system.

FIG. 24 is a view illustrating a functional configuration of a planned power system operation device in Example 5 and a functional configuration of a system planning system.

FIG. 25 is a view illustrating the planned power system operation system of Example 5 applied with the planned power system operation device and the system planning system described in FIG. 24.

### DESCRIPTION OF EMBODIMENTS

Embodiments of the present invention will be described below in detail with reference to the drawings.

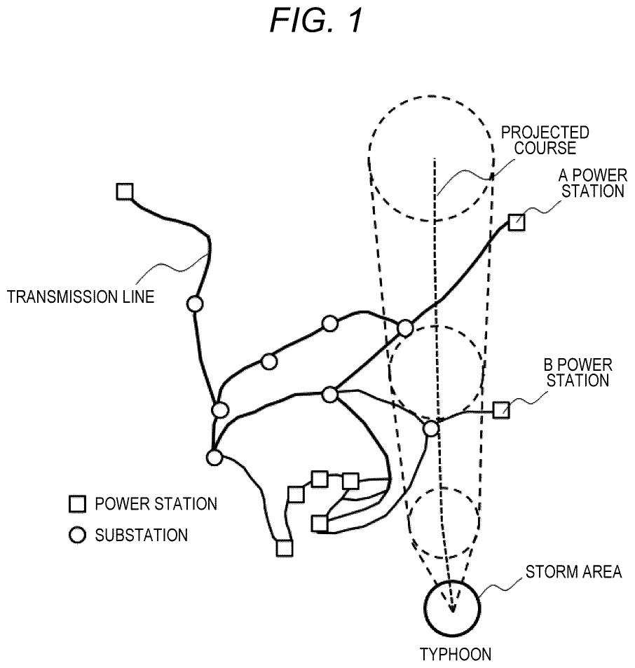

First, a processing outline of a planned power system operation device 10 of an embodiment will be described with reference to FIG. 1.

FIG. 1 is a view illustrating a relationship between a power system diagram when a typhoon is approaching and a projected course of the typhoon. The power system diagram of FIG. 1 indicates, on a map, power stations, substations, and transmission lines connecting them. As a typhoon passes, a transmission tower may collapse, the power transmission may be cut off, and a power outage may occur.

The planned power system operation device 10 predicts power transmission cutoff due to collapse of a transmission tower from a storm area in a projected course and the maximum wind speed of a typhoon, and changes the system operation such as a change of the power transmission route and a change of the power station output, thereby preventing an occurrence of a power outage.

Specifically, as illustrated in FIG. 1, it is predicted, from the projected course of the typhoon, that the transmission line of a power station B and the transmission line of a power station A sequentially enter the storm area, and the planned power system operation device 10 predicts power transmission cutoff at a predetermined cycle and changes the system operation. Note that in FIG. 1, a solid circle is a storm area, and a broken circle is a forecast cone.

When changing the system operation, there is a case where the planned power system operation device 10 can change the system operation so that outputs of the power station B and the power station A are substituted by increasing outputs of other power stations, but there is a case where the planned power system operation device 10 cannot substitute all of them, and a power outage occurs in some of them. An influence of a power outage varies depending on the area. Furthermore, the larger the number of power stations is, the more combination conditions for changing the system operation are.

Therefore, the planned power system operation device 10 calculates index values of reliability economy of a plurality of system operation candidates, and obtains a typhoon countermeasures result based on the index values.

The planned power system operation device 10 optimizes expansion of the transmission line, the substation, the phase modification equipment, and the like of a power system by obtaining the typhoon countermeasures result based on past typhoon courses together with the expansion of the transmission line, the substation, the phase modification equipment, and the like of the power system.

### Example 1

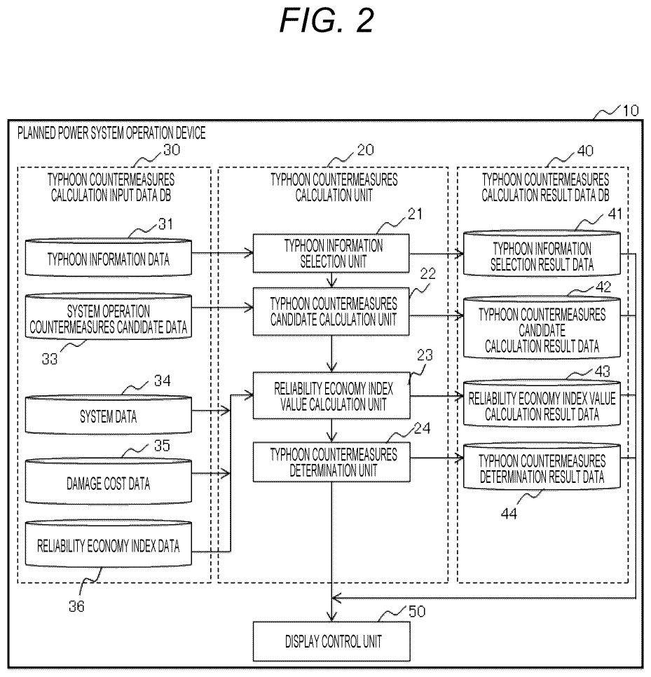

FIG. 2 is a view illustrating the functional configuration of the planned power system operation device 10 in Example 1.

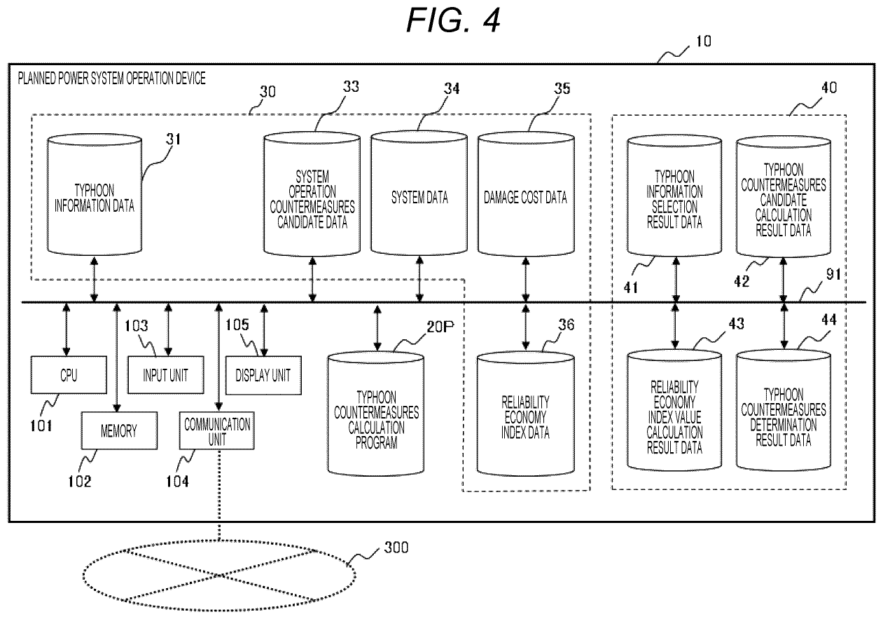

The planned power system operation device 10 includes a typhoon countermeasures calculation input data DB 30, which is a database (hereinafter, DB) that stores calculation input data of typhoon countermeasures by a typhoon, a typhoon countermeasures calculation unit 20 that obtains typhoon countermeasures using the typhoon countermeasures calculation input data DB 30, a typhoon countermeasures calculation result data DB 40 that stores the typhoon countermeasures obtained by the typhoon countermeasures calculation unit 20, and a display control unit 50 that performs display control when a typhoon countermeasures result is displayed on a display unit 105 (FIG. 4) described later.

Specifically, using the typhoon countermeasures calculation input data DB 30, the typhoon countermeasures calculation unit 20 selects typhoon information, calculates a typhoon countermeasures candidate for the selected typhoon information, calculates a reliability economy index value for the calculated typhoon countermeasures candidate, determines typhoon countermeasures based on the calculated reliability economy index value, and stores a typhoon countermeasures result into the typhoon countermeasures calculation result data DB 40.

The configurations of the typhoon countermeasures calculation input data DB 30, the typhoon countermeasures calculation unit 20, and the typhoon countermeasures calculation result data DB 40 will be described below in more detail.

The typhoon countermeasures calculation input data DB 30 stores typhoon information data 31, system operation countermeasures candidate data 33, system data 34, damage cost data 35, and reliability economy index data 36.

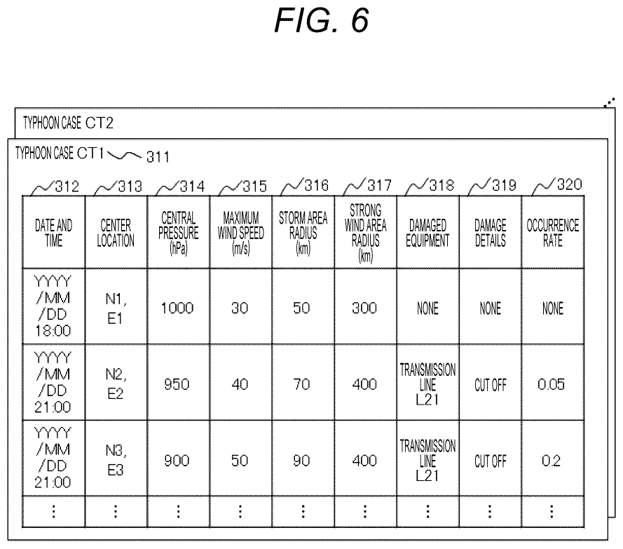

The typhoon information data 31, which will be described later in detail with reference to FIG. 6, is information indicating a projected course and a scale (maximum wind speed or the like) of a generated typhoon.

The system operation countermeasures candidate data 33, which will be described later in detail with reference to FIG. 8, is information indicating candidates for operation change for a typhoon damage in equipment such as a power station of the system. The typhoon countermeasures calculation unit 20 described later quantitatively calculates an effect when a countermeasures candidate for an estimated typhoon damage is implemented.

The system data 34 is a system configuration, a line impedance (R+jX), a ground capacitance (susceptance: jB), data necessary for system configuration and state estimations (such as a threshold of bat data), generator data, and data necessary for other power flow calculation, state estimation, and time series change calculation.

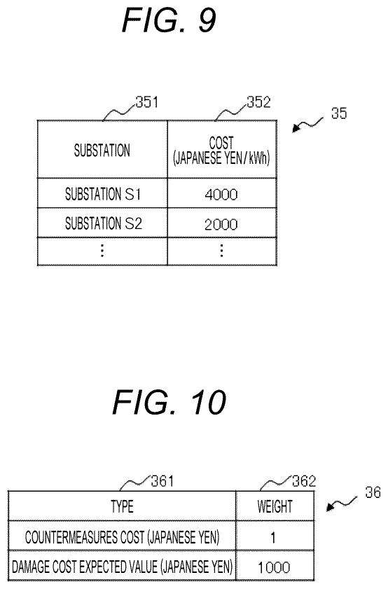

The damage cost data 35, which will be described later in detail with reference to FIG. 9, is information indicating a cost and the like associated with a power outage of a substation. The typhoon countermeasures calculation unit 20 described later quantitatively and accurately calculates a reliability economy index value for a typhoon countermeasures candidate with reference to the damage cost data 35.

The reliability economy index data 36, which will be described later in detail with reference to FIG. 10, is information indicating a weight for each type of reliability economy. The typhoon countermeasures calculation unit 20 described later scores, into the reliability economy index data 36, important facilities that need to avoid power outage as much as possible for social maintenance, and quantitatively calculates a reliability economy index value for a typhoon countermeasures candidate.

The typhoon countermeasures calculation result data DB 40 stores typhoon information selection result data 41, typhoon countermeasures candidate calculation result data 42, reliability economy index value calculation result data 43, and typhoon countermeasures determination result data 44.

The typhoon information selection result data 41 is typhoon information in which the planned power system operation device 10 of the embodiment has obtained a typhoon countermeasures candidate.

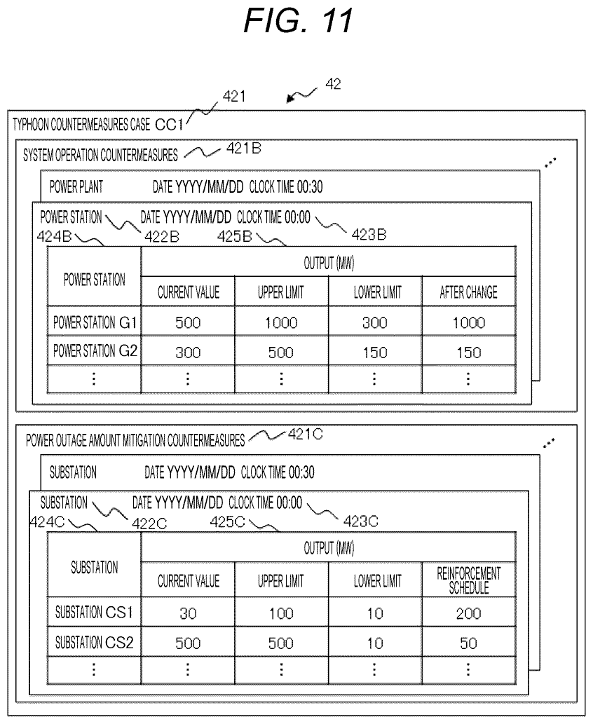

The typhoon countermeasures candidate calculation result data 42, which will be described later in detail with reference to FIG. 11, is information indicating a calculation result of countermeasures obtained by the planned power system operation device 10 of the embodiment.

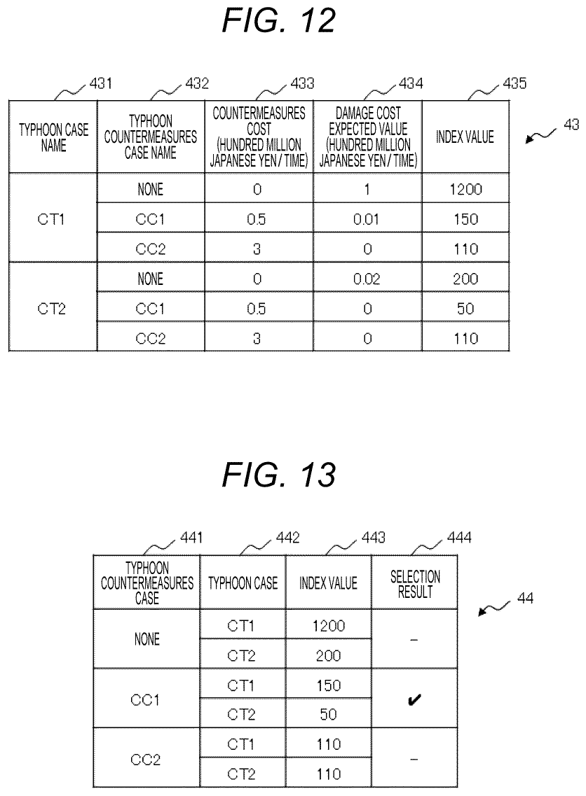

The reliability economy index value calculation result data 43, which will be described later in detail with reference to FIG. 12, is information indicating a reliability economy index value calculation result of the typhoon countermeasures for each typhoon countermeasure calculated by the planned power system operation device 10 of the embodiment, and is associated with the typhoon countermeasures candidate calculation result data 42.

The typhoon countermeasures determination result data 44, which will be described later in detail with reference to FIG. 13, is information displaying, for each typhoon countermeasures case, a list of reliability economy index values of the typhoon case calculated by the planned power system operation device 10 of the embodiment and information of selection results of the typhoon countermeasures cases. This makes it possible to compare calculation results of the reliability economy index values for typhoon countermeasures cases, and possible to easily confirm a selection result and a selection reason.

The information to be stored in the typhoon countermeasures calculation result data DB 40 includes not only data as a calculation result but also data at a time point of intermediate processing, and can be used as appropriate.

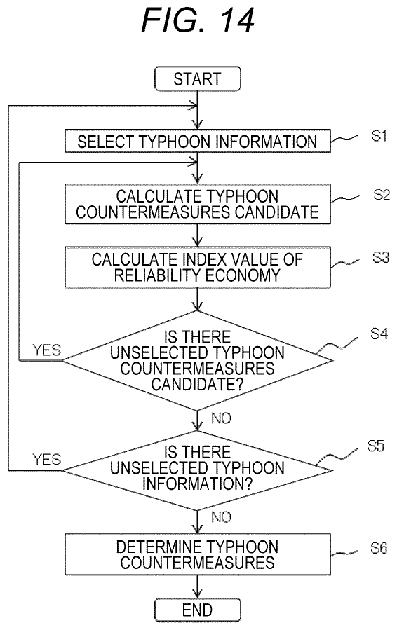

The typhoon countermeasures calculation unit 20 is a processing unit that obtains typhoon countermeasures, and includes a typhoon information selection unit 21, a typhoon countermeasures candidate calculation unit 22, a reliability economy index value calculation unit 23, and a typhoon countermeasures determination unit 24. The processing content of the typhoon countermeasures calculation unit 20 will be described below in more detail with reference to FIG. 14.

The typhoon information selection unit 21 selects typhoon information for which typhoon countermeasures are obtained from the typhoon information data 31, and outputs the selection result to the typhoon information selection result data 41.

Based on the typhoon information selected by the typhoon information selection unit 21, the typhoon countermeasures candidate calculation unit 22 calculates and outputs, as the typhoon countermeasures candidate calculation result data 42, a typhoon countermeasures candidate related to the system operation using the system operation countermeasures candidate data 33.

Using the system data 34, the damage cost data 35, and the reliability economy index data 36, the reliability economy index value calculation unit 23 calculates and outputs, as the reliability economy index value calculation result data 43, a reliability economy index value of a typhoon countermeasures candidate related to the system operation calculated by the typhoon countermeasures candidate calculation unit 22.

The typhoon countermeasures determination unit 24 determines and outputs, as the typhoon countermeasures determination result data 44, typhoon countermeasures related to the system operation based on the reliability economy index value calculated by the reliability economy index value calculation unit 23.

The display control unit 50 processes and displays, in an appropriately viewable form, various types of data handled in the planned power system operation device 10. The display control unit 50 reflects an input result of an input means such as a mouse and a keyboard onto a display screen.

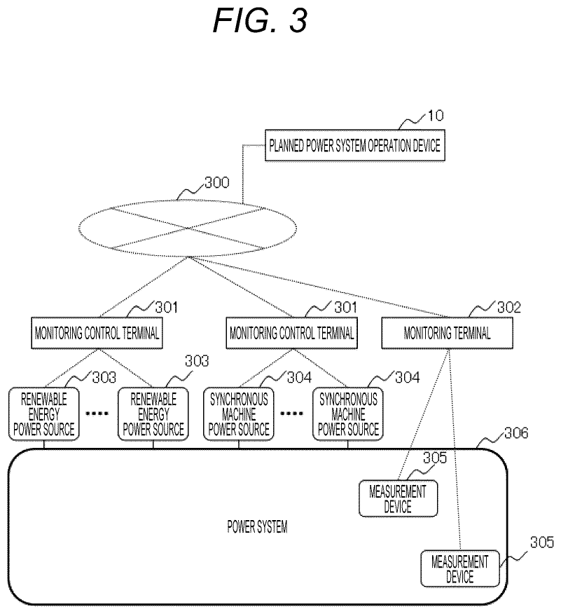

FIG. 3 is a view illustrating the planned power system operation system applied with the planned power system operation device 10 of Example 1.

Connected via a network 300 to a monitoring control terminal 301 that monitors and controls a synchronous machine power source 304 such as thermal power generation, nuclear power generation, and hydraulic power generation linked to a power system 306, a monitoring control terminal 301 that monitors and controls a renewable energy power source 303 such as photovoltaics and wind power generation, and a monitoring terminal 302 that monitors a measurement device 305 that measures a power flow distribution in the system of the power system 306, the planned power system operation device 10 transmits and receives data, and acquires an output and a power transmission state of the power station.

Next, the hardware configuration of the planned power system operation device 10 of Example 1 will be described with reference to FIG. 4.

The planned power system operation device 10 is a computer, an information processing device, or a computer server in which the display unit 105, an input unit 103 such as a keyboard or a mouse, a communication unit 104, a central processing unit (CPU) 101, a memory 102, and a storage device are connected by a bus line 91.

The storage device includes the typhoon countermeasures calculation input data DB 30 that stores, as a database, the typhoon information data 31, the system operation countermeasures candidate data 33, the system data 34, the damage cost data 35, and the reliability economy index data 36, the typhoon countermeasures calculation result data DB 40 that stores, as a database, the typhoon information selection result data 41, the typhoon countermeasures candidate calculation result data 42, the reliability economy index value calculation result data 43, and the typhoon countermeasures determination result data 44, and a typhoon countermeasures calculation program 20P.

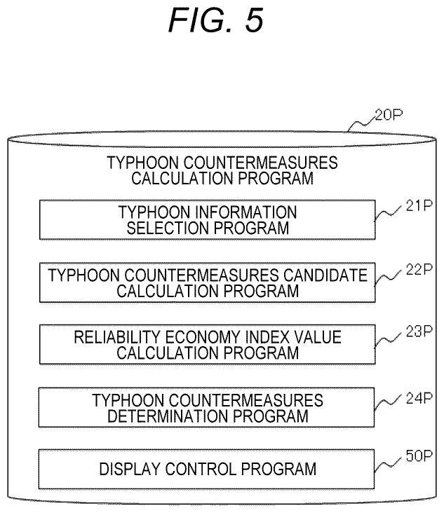

The CPU 101 executes a predetermined computer program of the typhoon countermeasures calculation program 20P described later with reference to FIG. 5 to implement the functions of the typhoon information selection unit 21, the typhoon countermeasures candidate calculation unit 22, the reliability economy index value calculation unit 23, and the typhoon countermeasures determination unit 24 of the typhoon countermeasures calculation unit 20, and the display control unit 50.

The display unit 105 is configured as a display device. The display unit 105 may be configured to use a printer device, a voice output device, or the like in place of the display device or together with the display device.

The display unit 105 of the planned power system operation device 10 may perform simple screen display only for rewriting each program and database, and display the candidate result of the obtained typhoon countermeasures onto a display device connected to the network 300.

The input unit 103 is configured to include at least any one of a keyboard switch, a pointing device such as a mouse, a touchscreen, and a voice instruction device.

The communication unit 104 includes a circuit and a communication protocol for connecting to the network 300.

The memory 102 includes a random access memory (RAM), stores a computer program read from the typhoon countermeasures calculation unit 20, and temporarily stores calculation result data, image data, and the like necessary for each processing. Screen data stored in the memory 102 are transmitted to and displayed on the display unit 105. An example of the screen to be displayed will be described later.

Specifically, the memory 102 temporarily stores calculation temporary data and calculation result data such as image data for display, the typhoon information selection result data 41, the typhoon countermeasures candidate calculation result data 42, the reliability economy index value calculation result data 43, and the typhoon countermeasures determination result data 44. The CPU 101 (display control unit 50) generates and displays, on the display unit 105 (e.g., a display display screen), necessary image data.

FIG. 5 is a view illustrating the configuration of the typhoon countermeasures calculation program 20P.

The typhoon countermeasures calculation program 20P stores a typhoon information selection program 21P, a typhoon countermeasures candidate calculation program 22P, a reliability economy index value calculation program 23P, a typhoon countermeasures determination program 24P, and a display program 50P.

The typhoon information selection program 21P is a program that selects typhoon information from the typhoon information data 31 and stores it in the typhoon information selection result data 41, and is executed by the CPU 101 to implement the typhoon information selection unit 21.

The typhoon countermeasures candidate calculation program 22P is a program that calculates and stores, as the typhoon countermeasures candidate calculation result data 42, a typhoon countermeasures candidate related to the system operation using the system operation countermeasures candidate data 33 regarding the typhoon information selected by the typhoon information selection unit 21, and is executed by the CPU 101 to implement the typhoon countermeasures candidate calculation unit 22.

The reliability economy index value calculation program 23P is a program that calculates and stores, as the reliability economy index value calculation result data 43, a reliability economy index value of the typhoon countermeasures candidate related to the system operation calculated by the typhoon countermeasures candidate calculation unit 22 using the system data 34, the damage cost data 35, and the reliability economy index data 36, and is executed by the CPU 101 to implement the reliability economy index value calculation unit 23.

Specifically, the reliability economy index value indicates the power supply reliability of the expected value of the number of times, time, or shortage power of occurrence of the power supply shortage when countermeasures of the typhoon countermeasures candidate is implemented, and the economy such as the cost for implementing the countermeasures of the typhoon countermeasures candidate, and is a numerical value for quantitatively comparing the typhoon countermeasures candidates.

The typhoon countermeasures determination program 24P is a program that determines and stores, as the typhoon countermeasures determination result data 44, typhoon countermeasures related to the system operation based on the reliability economy index value calculated by the reliability economy index value calculation unit 23, and is executed by the CPU 101 to implement the typhoon countermeasures determination unit 24.

The display program 50P is a program that processes and displays, in an appropriately viewable form, various types of data handled in the planned power system operation device 10 and reflects an input result of an input means such as a mouse and a keyboard onto the display screen, and is executed by the CPU 101 to implement the display control unit 50.

Hereinafter, the content of the typhoon countermeasures calculation input data DB 30 and the typhoon countermeasures calculation result data DB 40 will be described in detail.

FIG. 6 is a view illustrating the configuration of the typhoon information data 31 of the typhoon countermeasures calculation input data DB 30. The typhoon information data 31 indicates the scale of a typhoon and predicted typhoon damage for each projected course of a generated typhoon. Note that information such as collapse of a tower due to a flood caused by a typhoon and a lightning strike may be included as the type of the typhoon damage.

Specifically, the typhoon information data 31 includes, for each typhoon case 311, the scale of a typhoon such as a center location 313, a central pressure 314, a maximum wind speed 315, a storm area radius 316, and a strong wind area radius 317 of the typhoon on date and time 312 of a projected course, and the typhoon damage such as predicted damaged equipment 318, damage details 319, and a damage occurrence rate 320 due to the typhoon on the date and time 312 of the projected course.

Specifically, when the typhoon case 311 is a typhoon case CT1 and the date and time 312 of the projected course is 18:00 of MM/DD/YYYY, the center location 313 is at a north latitude N1 and an east longitude E1, the central pressure 314 is 1000 hPa, the maximum wind speed 315 is 30 m/s, the storm area radius 316 is 50 km, and the strong wind area radius 317 is 300 km, and it is indicated that there are no damaged equipment 318, no damage details 319, and no occurrence rate 320 due to the typhoon of this date and time.

When the date and time 312 of the projected course is 21:00 of MM/DD/YYYY, the center location 313 is at a north latitude N2 and an east longitude E2, the central pressure 314 is 950 hPa, the maximum wind speed 315 is 40 m/s, the storm area radius 316 is 70 km, and the strong wind area radius 317 is 400 km, and it is indicated that on this date and time, a typhoon damage in which the damaged equipment 318 is a transmission line L21, the damage details 319 is cutoff, and the occurrence rate 320 is 0.05 is predicted.

Note that regarding the wind speed, according to the website of Japan Meteorological Agency, the wind speed is an average wind speed for 10 minutes, and the maximum wind speed is the maximum value of the average wind speed for 10 minutes. The instantaneous wind speed is a value (average of 12 measurement values) in which measurement values (0.25 second intervals) of an anemometer are averaged for 3 seconds, and the maximum instantaneous wind speed is the maximum value of the instantaneous wind speed. Also in the present disclosure, the wind speed is the same as defined by Japan Meteorological Agency, but is not limited to this. The maximum wind speed may be a wind speed.

Thus, unlike disasters such as an earthquake, an influence of a typhoon has characteristics of a damage range, a damage rate, a damage scale, and the like that change in accordance with the progress of the typhoon. Unlike disasters such as an earthquake, temporal prediction and prediction of the magnitude of hazard such as wind speed are easy. Therefore, in the present example, each risk is evaluated up to a future time section using prediction data of the typhoon, and the total risk until the typhoon goes by is evaluated.

Here, the occurrence rate 320 of a cutoff damage of a transmission line will be described.

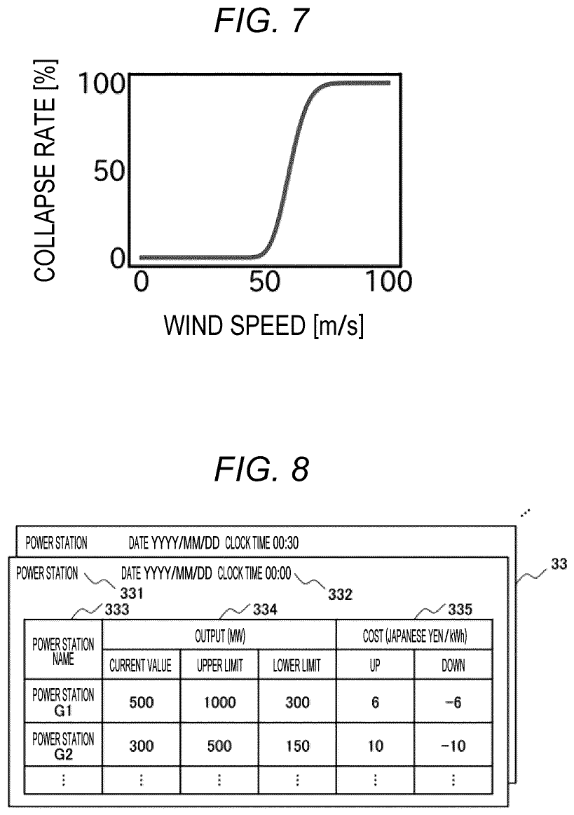

Collapse rate of a structure such as a transmission tower is almost 0 until a certain wind speed is reached, and when the wind speed exceeds a wind speed at which a design margin is expected in a design basis wind speed, the collapse rate rapidly increases in general. Therefore, as illustrated in FIG. 7, the occurrence rate 320 is indicated by a probability distribution function (also called a fragility curve) in which the horizontal axis represents the wind speed with respect to the tower and the vertical axis represents the collapse rate.

The wind speed at the point of the tower is predicted from the projected course of the typhoon, and the collapse rate of the tower is calculated from the fragility curve of FIG. 7. The occurrence rate of the cutoff damage of the transmission line is a rate at which collapse occurs in any one of the towers included in the transmission line. In this manner, the occurrence rate of the cutoff damage of the transmission line is calculated.

FIG. 8 is a view illustrating the configuration of the system operation countermeasures candidate data 33 of the typhoon countermeasures calculation input data DB 30. The system operation countermeasures candidate data 33 is information indicating a candidate of an operation change for the typhoon damage in the system operation countermeasures type that is equipment of the system. FIG. 8 illustrates a case of an operation change of the power station for each predetermined date and time as the system operation countermeasures type.

Specifically, the system operation countermeasures candidate data 33 for a predetermined system operation countermeasures type includes, for each date and time 332, a power station name 333, an output 334 (current value, output upper limit value, and output lower limit value) of the power station, and a cost 335 (up/down) necessary for output change of the power station.

Specifically, FIG. 8 indicates that when a system operation countermeasures type 331 is a power station and the date and time 332 is 0:00 of MM/DD/YYYY, the current output of a power station G1 is 500 MW, the output upper limit is 1000 MW, the output lower limit is 300 MW, the cost for an output increase is 6 Japanese Yen (JPY)/kWh, and the cost for an output decrease is −6 JPY/kWh.

By the system operation countermeasures candidate data 33, for example, the output of the power station G1 is reduced and the output of a power station G2 is increased, whereby the amount of power flowing through a part where disconnection due to collapse of a tower by the typhoon is likely to occur is reduced, or the amount of power at a part where an expected value to become overload is high when disconnection occurs is reduced. This reduces a power outage risk.

Although FIG. 8 indicates the system operation countermeasures candidate data 33 in a case where the system operation countermeasures type 331 is a power station, the system operation countermeasures type 331 may be system operation countermeasures other than the operation change of the power station, for example, start or stop of the power station, change of a substation tap, on or off of substation phase modification equipment, and on or off of a transmission line, or may be other system operation countermeasures.

The system operation countermeasures candidate data 33 can implement a typhoon countermeasures candidate related to the system operation. It is possible to quantitatively and accurately calculate the reliability economy index values such as the cost for the typhoon countermeasures candidate. These index values are evaluated in all time sections from the time when the typhoon is approaching to the time when the typhoon has gone by.

FIG. 9 is a view illustrating the configuration of the damage cost data 35 of the typhoon countermeasures calculation input data DB 30. The damage cost data 35 is information indicating the cost or the like associated with a power outage of a substation.

Specifically, the damage cost data 35 includes a substation name 351 and a cost 352 associated with a power outage of the substation.

Specifically, FIG. 9 indicates that the substation whose substation name 351 is a substation S1 has a damage with a cost 352 of 4000 JPY/kWh due to the power outage.

The damage cost data 35 may be a cost for each consumer, may be a cost for each consumer type (general household, factory, office, hospital, and the like), or may be another type. That is, the damage cost data 35 is at least any one of the power outage cost for each substation, the power outage cost for each consumer, and the power outage cost for each consumer type. By including the above information, it is possible to quantitatively and accurately calculate the reliability economy index value for the typhoon countermeasures candidate.

FIG. 10 is a view illustrating the configuration of the reliability economy index data 36 of the typhoon countermeasures calculation input data DB 30. The reliability economy index data 36 is information indicating a weight for each type of reliability economy.

Specifically, the reliability economy index data 36 includes a type 361 of the reliability economy index and a weight coefficient 362 for each index.

Specifically, FIG. 10 indicates that the type 361 of the reliability economy index includes a countermeasures cost and a damage cost expected value, the weight 362 of the countermeasures cost is 1, and the weight 362 of the damage cost expected value is 1000.

The type 361 of the reliability economy index value may be loss of load probability (LOLP), loss of load expectation (LOLE), or expected unserved energy (EUE), may be value of lost load (VOLL), may be an index (presence of loss of synchronism of a generator, a maximum value of an internal phase angle of the generator, a load margin to a nose point of a P-V curve, a short circuit capacity, a short circuit ratio (SCR), a maximum frequency reduction value, a rate of change of frequency (RoCoF), an overload rate of a transmission line, and an overload amount of a transmission line) related to system stability (synchronous stability, voltage stability, frequency stability, overload, and the like), or may be another index. It may be an economy index such as GDP to be lost by the power outage, or for example, important government offices, hospitals, and the like that need to avoid the power outage as much as possible in order to maintain the social function may be scored.

With the reliability economy index data 36, it is possible to quantitatively calculate the reliability economy index value for the typhoon countermeasures candidate.

FIG. 11 is a view illustrating the configuration of the typhoon countermeasures candidate calculation result data 42 of the typhoon countermeasures calculation result data DB 40. The typhoon countermeasures candidate calculation result data 42 is information indicating a calculation result of typhoon countermeasures for each typhoon countermeasures case name 421. The typhoon countermeasures candidate calculation result data 42 includes information on system operation countermeasures 421B and power outage amount mitigation countermeasures 421C.

In the system operation countermeasures 421B of the typhoon countermeasures candidate calculation result data 42, the system operation countermeasures stored in the system operation countermeasures candidate data 33 are stored for each system operation countermeasures type 422B.

Specifically, in a case where the system operation countermeasures type 422B is operation change of the power station, a power station name 424B and information 425B on an output value before change (current value), an output upper limit value, an output lower limit value, and an output value after change of the power station are stored for each date and time 423B. Note that in FIG. 11, the typhoon countermeasures case name 421 is a “typhoon countermeasures case CC1”.

Specifically, when the typhoon countermeasures case 421 of FIG. 11 is the typhoon countermeasures case CC1, the system operation countermeasures 421B are indicated to change the output of the power station G1 of 0:00 of MM/DD/YYYY from 500 MW to 1000 MW, and change the output of the power station G2 from 300 MW to 150 MW.

The power outage amount mitigation countermeasures 421C of the typhoon countermeasures candidate calculation result data 42 are stored for each of the power outage amount mitigation countermeasures stored in the system operation countermeasures candidate data 33.

Specifically, in a case where a power outage amount mitigation countermeasures type 422C is a substation indicating deployment of a power supply car to a substation and a change in the operation output, a substation name 424C for deployment, and information 425C on an output value before change (current value), an output upper limit value, an output lower limit value, and an output value after change of the power supply car deployment of the substation and a future reinforcement schedule are stored for each date and time 423C.

Specifically, when the typhoon countermeasures case name 421 is the typhoon countermeasures case CC1 of FIG. 11, it is indicated that the output of a substation CS1 of 0:00 Of MM/DD/YYYY is 30 MW, the output can be increased to 100 MW in the future, and reinforcement by 200 MW is scheduled.

The typhoon countermeasures case CC1 of FIG. 11 is a case where both of the system operation countermeasures 421B (i.e., operation change of the power station) and the power outage amount mitigation countermeasures 421C (i.e., deployment of the power supply car to the substation and change of the operation output) are implemented as the typhoon countermeasures, but may be implemented independently of each other. The system operation countermeasures type 422B (operation change of the power station in FIG. 11) may be other system operation countermeasures described in the description of the system operation countermeasures candidate data 33. Other than the deployment of the power supply car to the substation, other countermeasures methods such as demand restraint (demand response) and control of charging and discharging of an electric vehicle may be taken as the power outage mitigation countermeasures.

It is necessary to provide a system that can select optimal countermeasures by combining these countermeasures described above, but the combination of them is enormous, and there are many matters that need to be considered, such as taking countermeasures not significantly raising a power outage risk even when the prediction of a typhoon is wrong. Therefore, an algorithm that narrows down and displays more optimal countermeasures from a large number of countermeasures in combination with reinforcement learning or the like may be provided.

Since there are a large number of transmission lines, there are an infinite number of combinations of transmission lines that are disconnected. When the calculation is performed on an assumption of all these combinations, the calculation time becomes enormous. Therefore, it is conceivable to reduce the number of assumed cases by setting conditions. For this reduction, there is also a method of using those having a probability equal to or greater than a certain value using an occurrence rate. However, other than this, the number of evaluation cases may be reduced using, as an evaluation index, not the probability but a power outage risk in which a disconnection rate is multiplied by a power outage amount when the line is disconnected, a power transmission risk in which the disconnection rate is multiplied by an amount of power flowing through the line, or the like.

The typhoon countermeasures candidate calculation result data 42 can implement each typhoon countermeasures candidate. It is possible to quantitatively and accurately calculate the reliability economy index value (index value of reliability economy) for the typhoon countermeasures candidate.

FIG. 12 is a view illustrating the configuration of the reliability economy index value calculation result data 43 of the typhoon countermeasures calculation result data DB 40. The reliability economy index value calculation result data 43 is information indicating a reliability economy index value calculation result of the typhoon countermeasures for each typhoon countermeasure, and is associated with the typhoon countermeasures candidate calculation result data 42.

The reliability economy index value calculation result data 43 includes information on a typhoon case name 431 corresponding to a typhoon case stored in the typhoon information selection result data 41 (see FIG. 4), a typhoon countermeasures case name 432 corresponding to a typhoon countermeasures case (the typhoon countermeasures case name 421) stored in the typhoon countermeasures candidate calculation result data 42 (see FIG. 11), a countermeasures cost 433 per one time at the time of implementation of the typhoon countermeasures case, a damage cost expected value 434 per one time at the time of implementation of the typhoon countermeasures case, and an index value 435 of reliability economy for implementation of the typhoon countermeasures case.

The countermeasures cost 433 per one time at the time of implementation of the typhoon countermeasures case is obtained by multiplying the cost 335 of the system operation countermeasures candidate data 33 corresponding to the system operation countermeasures implemented in the typhoon countermeasures case 421, for example, by a difference value before and after a power station output change (operation change). An additional cost caused by the power supply car deployment to the substation or the like is also added.

The damage cost expected value 434 per one time at the time of implementation of the typhoon countermeasures case is obtained as follows.

First, the system stability (synchronous stability, voltage stability, frequency stability, overload, and the like) is evaluated by system analysis simulating the equipment damage details generated in the typhoon case and the system operation countermeasures implemented in the typhoon countermeasures case (the typhoon countermeasures case CC1, CC2, or the like) of the typhoon countermeasures case name 432.

When the synchronous stability or the voltage stability cannot be maintained, the cost 352 stored in the damage cost data 35 is obtained on an assumption that the power outage occurs in an analysis target area. On the other hand, when the frequency decreases, a cutoff amount of the load (substation) simulating the operation of an under frequency relay (UFR) is obtained, and the cost 352 stored in the damage cost data 35 is obtained on an assumption that the power outage occurs due to the substation cut off in the analysis target area.

When an overload occurs, the cost 352 stored in the damage cost data 35 (FIG. 9) is obtained on an assumption that the power outage occurs by the substation leading to a lower side of the transmission line in which the overload occurs. Furthermore, by multiplying the obtained damage cost by the occurrence rate of an equipment damage occurring in the typhoon case, the damage cost expected value 434 per one time at the time of implementation of the typhoon countermeasures case is obtained.

For example, the index value 435 of the reliability economy at the time of implementation of the typhoon countermeasures case is obtained as a weighted sum (weighted average value) of the weight coefficient 362 stored in the corresponding reliability economy index data 36 for the countermeasures cost 433 per one time and the damage cost expected value 434 per one time corresponding to the typhoon case having the typhoon case name 431 and the typhoon countermeasures case having the typhoon countermeasures case name 432.

Specifically, FIG. 12 indicates that the countermeasures cost is 50 million JPY/time, the damage cost expected value is 1 million JPY/time, and the reliability economy index value is 150 as a result of implementing the typhoon countermeasures case CC1 having the typhoon countermeasures name 432 for the typhoon case CT1 having the typhoon case name 431. Note that the calculation of the countermeasures cost 433 per one time at the time of implementation of the typhoon countermeasures case, the damage cost expected value 434 per one time at the time of implementation of the typhoon countermeasures case, and the index value 435 of the reliability economy at the time of implementation of the typhoon countermeasures case may be obtained by methods other than the above.

The countermeasures cost 433 per one time at the time of implementation of the typhoon countermeasures case and the damage cost expected value 434 per one time at the time of implementation of the typhoon countermeasures case may be a specific number of hours (e.g., a case of limiting to only the time during which the typhoon lands on the Japanese main island).

The reliability economy index value calculation result data 43 makes it possible to quantitatively calculate and compare the reliability economy index values for each typhoon case (CT1, CT2, and the like) and each typhoon countermeasures case (none, CC1, CC2, and the like).

FIG. 13 is a view illustrating the configuration of the typhoon countermeasures determination result data 44 of the typhoon countermeasures calculation result data DB 40. The typhoon countermeasures determination result data 44 is information displaying, for each typhoon countermeasures case, a list of reliability economy index values (index values of reliability economy) of the typhoon case and information of selection results of the typhoon countermeasures cases.

The typhoon countermeasures determination result data 44 includes information on a typhoon countermeasures case name 441 corresponding to a typhoon countermeasures case having the typhoon countermeasures case name 432 stored in the reliability economy index value calculation result data 43 (FIG. 12), a typhoon case having a typhoon countermeasures case name 442, and a selection result 444 as a typhoon countermeasure for the index value 435 of reliability economy.

Selection of typhoon countermeasures is made by, for example, selecting a typhoon countermeasures case having the smallest sum of index values 443 of reliability economy for a typhoon case of each typhoon case 442 in the typhoon countermeasures of the typhoon countermeasures case name 441. For example, FIG. 13 indicates that CC1 is selected as the typhoon countermeasures case. Note that selection of the typhoon countermeasures may be selected by a method other than the above.

The typhoon countermeasures determination result data 44 makes it possible to compare calculation results of the index values of the reliability economy for each typhoon countermeasures case (none, CC1, CC2, and the like) and each typhoon case, and possible to easily confirm a selection result and a selection reason. Since it is possible to select typhoon countermeasures that can reduce the countermeasures cost and the damage cost, it is possible to achieve reduction in social cost and improvement in power resilience.

Next, the processing flow of the typhoon countermeasures calculation unit 20 (see FIG. 2) of the planned power system operation device 10 will be described with reference to FIG. 14.

In step S1, the typhoon information selection unit 21 of the typhoon countermeasures calculation unit 20 selects the typhoon information stored in the typhoon information data 31 (see FIG. 6) using the typhoon information data 31, and outputs the selection result as the typhoon information selection result data 41.

In step S2, using the typhoon information selection result data 41 and the system operation countermeasures candidate data 33, the typhoon information selection unit 21 of the typhoon countermeasures calculation unit 20 calculates and outputs, as the typhoon countermeasures candidate calculation result data 42 (see FIG. 11), a countermeasures candidate related to the system operation for the typhoon selected in step S1.

In step S3, using the typhoon countermeasures candidate calculation result data 42, the system data 34, the damage cost data 35, and the reliability economy index data 36, the reliability economy index value calculation unit 23 of the typhoon countermeasures calculation unit 20 calculates and outputs, as the reliability economy index value calculation result data 43 (see FIG. 12), an index value of reliability economy for the typhoon countermeasures candidate calculated by the typhoon countermeasures candidate calculation unit 22.

In step S4, the typhoon countermeasures determination unit 24 of the typhoon countermeasures calculation unit 20 determines presence of an unselected typhoon countermeasures candidate in step S2 regarding the typhoon information selected in step S1. If there is an unselected typhoon countermeasures candidate (YES in S4), the process returns to step S2. If there is no unselected typhoon countermeasures candidate (NO in S4), the process proceeds to step S5.

In step S5, the typhoon countermeasures determination unit 24 determines the presence of unselected typhoon information in step S1. If there is unselected typhoon information (YES in S5), the process returns to step S1. If there is no unselected typhoon information (NO in S5), the process proceeds to step S6.

In step S6, using the reliability economy index value calculation result data 43, the typhoon countermeasures determination unit 24 determines and outputs, as the typhoon countermeasures determination result data 44 (see FIG. 13), typhoon countermeasures.

Based on the index value of the reliability economy calculated from the typhoon information data, the system operation countermeasures candidate data, the damage cost data, the system data, and the reliability economy index data, by the above processing, the typhoon countermeasures calculation unit 20 can select typhoon countermeasures that can reduce the countermeasures cost and the damage cost, it is possible to achieve reduction in social cost and improvement in power resilience.

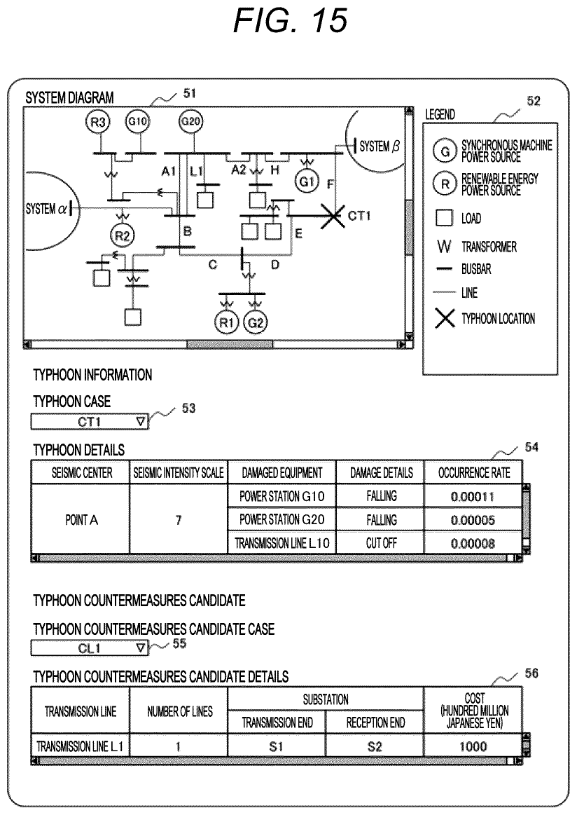

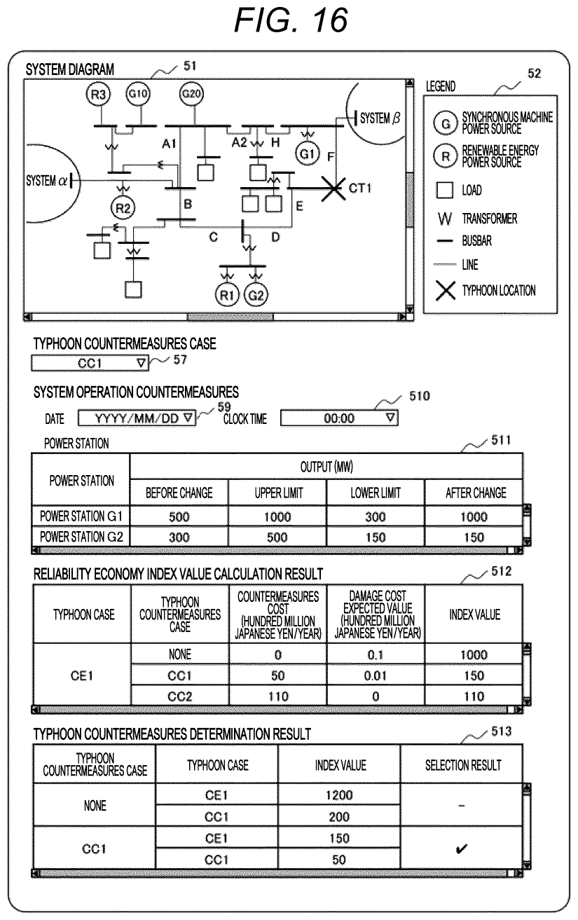

Next, FIGS. 15 and 16 indicate display examples output to the display unit 105 by the display control unit 50 (see FIG. 2) of the typhoon countermeasures calculation unit 20.

FIG. 15 displays a typhoon case 53 and typhoon details 54 in typhoon information, and a typhoon countermeasures candidate case 55 and typhoon countermeasures candidate details 56 in a typhoon countermeasures candidate. These display data items can be freely selected by the user.

The display of FIG. 15 includes a system diagram 51 and a legend 52 together, and has a display form for the user to easily understand the location of the typhoon countermeasures candidate.

FIG. 16 is another example of the display content. FIG. 16 displays a typhoon countermeasures case 57, a date 59, a time 510, and details 511 in the system operation countermeasure, a reliability economy index value calculation result 512, and a typhoon countermeasures determination result 513. These display data items can be freely selected by the user.

The display of FIG. 16 also includes the system diagram 51 and the legend 52, and has a display form for the user to easily understand the location of the typhoon countermeasures.

### Example 2

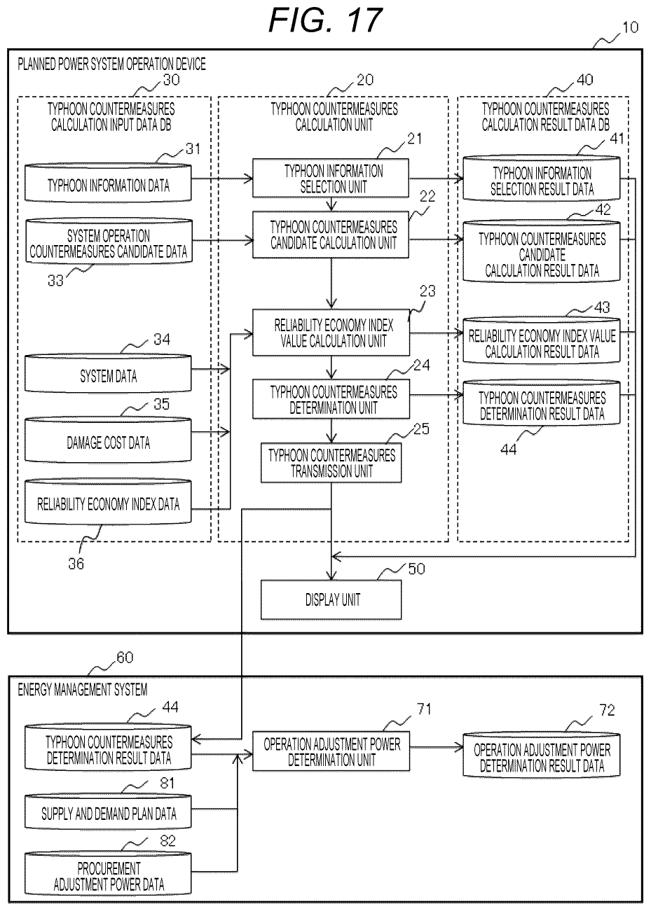

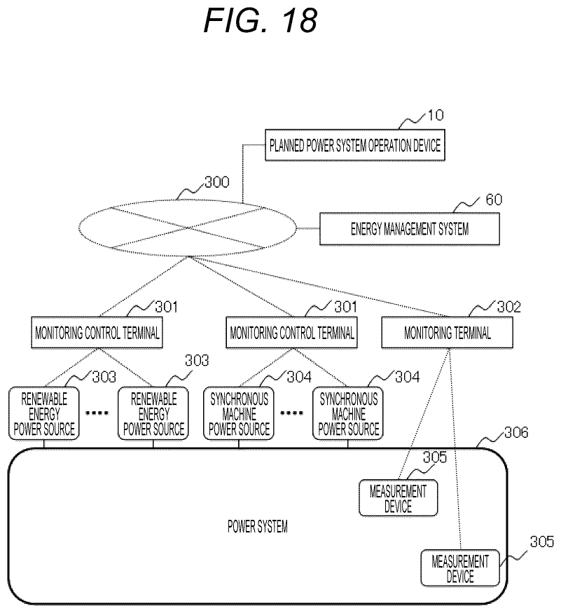

Next, an example in which the planned power system operation device 10 transmits the typhoon countermeasures determination result data 44 (see FIG. 13) to the energy management system (EMS), and the energy management system reduces an adjustment power operation cost and improves power resilience will be described with reference to FIGS. 17 and 18.

FIG. 7 is a view illustrating the functional configuration of the planned power system operation device 10 in Example 2 and the functional configuration of an energy management system 60.

The planned power system operation device 10 of FIG. 17 is different from the planned power system operation device 10 of FIG. 2 in adding a typhoon countermeasures transmission unit 25 that transmits, to the energy management system 60, the typhoon countermeasures determination result data 44 determined the typhoon countermeasures determination unit 24. Since other configurations of the planned power system operation device 10 are similar to those of FIG. 2, the description thereof is omitted here.

The energy management system 60 includes a database that stores the typhoon countermeasures determination result data 44, supply and demand plan data 81, procurement adjustment power data 82, and operation adjustment power determination result data 72, and an operation adjustment power determination unit 71.

The typhoon countermeasures determination result data 44 is information transmitted from the typhoon countermeasures transmission unit 25 of the planned power system operation device 10.

The supply and demand plan data 81 is information regarding a power generation plan and a supply and demand plan provided from a power generation operator and a retailer to a general power transmission/distribution operator.

The procurement adjustment power data 82 is information on the adjustment power procured in a supply and demand adjustment market.

The operation adjustment power determination result data 72 is information regarding the determination result of the adjustment power to be operated.

The operation adjustment power determination unit 71 determines an adjustment power to be operated using the typhoon countermeasures determination result data 44, the supply and demand plan data 81, and the procurement adjustment power data 82, and outputs the operation adjustment power determination result data 72.

Specifically, the operation adjustment power determination unit 71 predicts imbalance between power generation and a load from the supply and demand plan data 81, and obtains, in a merit order, a power station output change amount in which the imbalance can be adjusted from the adjustment power stored in the procurement adjustment power data 82 and the power station output change amount stored in the typhoon countermeasures determination result data 44. Note that the determination method of the operation adjustment power may be a method other than the above.

As described above, in addition to suppression of supply and demand and frequency fluctuation with respect to imbalance between the power generation and the demand, it is possible to operate the adjustment power that can perform both reduction in adjustment power operation cost and improvement in power resilience.

FIG. 18 is a view illustrating the planned power system operation system of Example 2 applied with the planned power system operation device 10 and the energy management system 60 described in FIG. 17.

The planned power system operation system of FIG. 18 is different from the planned power system operation system of FIG. 3 in adding the energy management system 60 connected to the planned power system operation device 10 via the network 300.

In the present example, the planned power system operation device 10 can transmit and receive data via the energy management system 60 and the network 300, but the planned power system operation device 10 may be an internal device of the energy management system 60 and transmit and receive data via an internal communication network.

In the present example, an example in which the transmission destination of the typhoon countermeasures determination result data 44 is the energy management system 60 has been described, but the transmission destination may be, in place of the energy management system 60, a system stabilization system, a core management system, a system management system, a market management system, and the like.

### Example 3

In Example 3, a case will be described in which not actual typhoon prediction data but statistical data of past typhoons and the like are input and utilized for reinforcement of a substation, reinforcement of a transmission line, and the like with respect to Example 1.

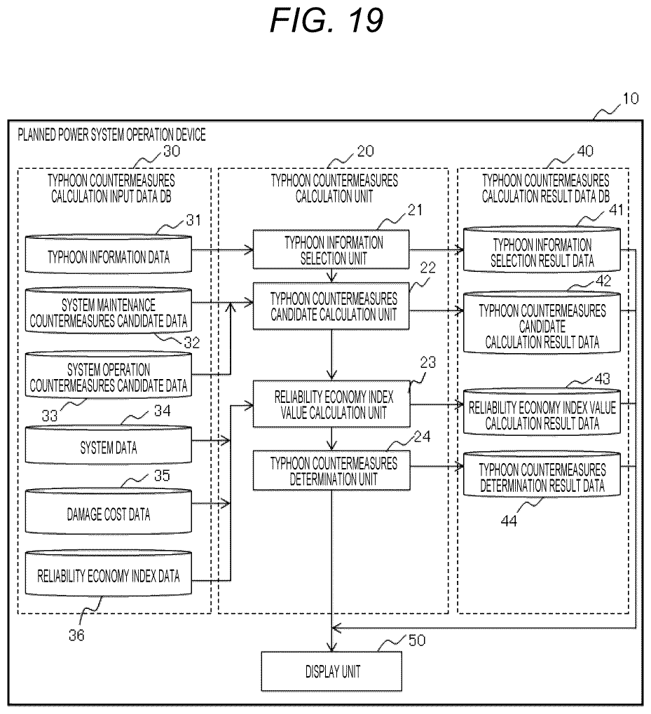

FIG. 19 is a view illustrating the functional configuration of the planned power system operation device 10 in Example 3.

The planned power system operation device 10 in Example 3 is different from the planned power system operation device described with reference to FIG. 2 in that the typhoon information data 31 is information indicating the course and the scale of a past typhoon, and weakness of the power system is statistically grasped by inputting a large number of past typhoon data.

There is a difference in that the typhoon countermeasures calculation input data DB 30 records system maintenance countermeasures candidate data 32 described later in detail, and the typhoon countermeasures candidate calculation unit 22 calculates and outputs, as the typhoon countermeasures candidate calculation result data 42 (see FIG. 11), a typhoon countermeasures candidate related to the system the system maintenance operation using countermeasures candidate data 32 and the system operation countermeasures candidate data 33 for the typhoon information selected by the typhoon information selection unit 21.

Details of the system maintenance countermeasures candidate data 32 and the typhoon countermeasures candidate calculation result data 42 will be described below.

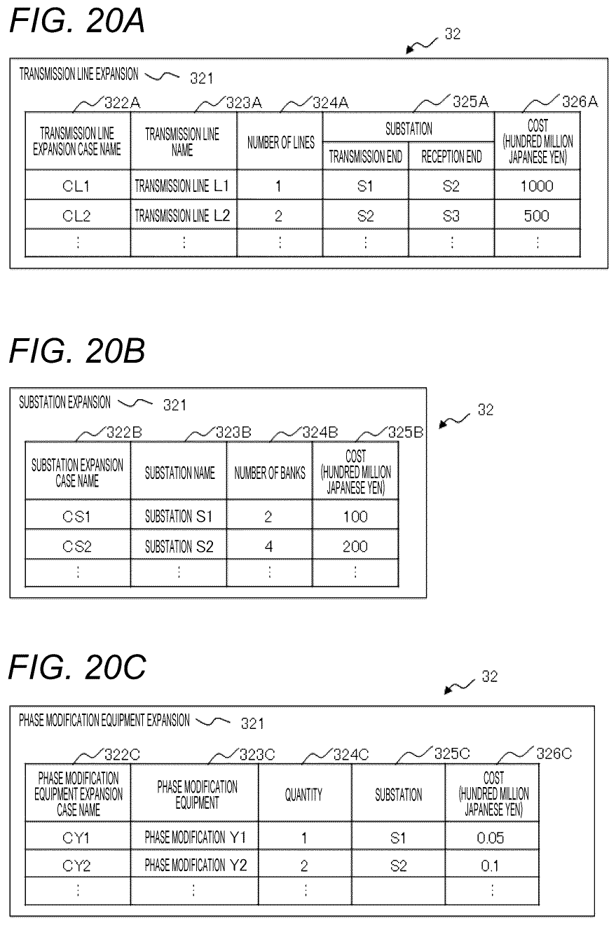

First, details of the system maintenance countermeasures candidate data 32 will be described with reference to FIGS. 20A, 20B, and 20C.

FIG. 20A illustrates the configuration of the system maintenance countermeasures candidate data 32 in a case where a system maintenance countermeasures type 321 is transmission line expansion.

In this case, the system maintenance countermeasures candidate data 32 stores information on a transmission line name 323A (power transmission lines L1, L2, and the like), the number of lines 324A (1, 2, and the like) of the transmission lines, a substation name 325A of a transmission end and a reception end of the transmission line, and a cost 326A required for expansion of the transmission line in a transmission line expansion case name 322A.

Specifically, the transmission line expansion case whose transmission line expansion case name 322A is CL1 in FIG. 20A indicates expansion, at a cost of 100 billion JPY, of the transmission line L1 with the number of lines of 1 connecting the substation S1 of the transmission end and a substation S2 of the reception end.

FIG. 20B illustrates the configuration of the system maintenance countermeasures candidate data 32 in a case where the system maintenance countermeasures type 321 is substation expansion.

In this case, the system maintenance countermeasures candidate data 32 stores information on a substation name 322B (substations S1, S2, and the like), the number of transformer banks 324B of the substation, and a cost 325B required for expansion of the substation in a substation expansion case name 323B (CS1, CS2, and the like).

Specifically, the substation expansion case whose substation expansion case name 322B is CS1 in FIG. 20B indicates expansion of the substation S1 with the number of banks 2 at a cost of 10 billion JPY.

FIG. 20C illustrates the configuration of the system maintenance countermeasures candidate data 32 in a case where the system maintenance countermeasures type 321 is phase modification equipment expansion.

In this case, the system maintenance countermeasures candidate data 32 stores information on a phase modification equipment expansion case (CY1, CY2, and the like) in a phase modification equipment expansion case name 322C, a phase modification equipment name (phase modifications Y1, Y2, and the like) in a phase modification equipment name 323C, the number of pieces of phase modification equipment 324C, a substation name 325C for expansion of the phase modification equipment, and a cost 326C required for expansion of the phase modification equipment.

Specifically, the phase modification equipment expansion case whose phase modification equipment expansion case name 322C is CY1 in FIG. 20C indicates expansion of one piece of phase modification equipment Y1 to the substation S1 at a cost of 5 million JPY. Here, the phase modification equipment is a static condenser (SC), a shunt reactor (ShR), or the like.

The system maintenance countermeasures type 321 may be system maintenance countermeasures other than transmission line expansion, substation expansion, and phase modification equipment expansion, for example, high voltage direct current (HVDC) equipment, a synchronous phase modification machine, a static var compensator (SVC), a self-excited SVC, a static var generator (SVG), a static synchronous compensator (STATCOM), or a phase shifter, or may be other system maintenance countermeasures.

By providing the system maintenance countermeasures candidate data 32, it is possible to implement a typhoon countermeasures candidate related to system maintenance. It is possible to quantitatively and accurately calculate the reliability economy index value for the typhoon countermeasures candidate.

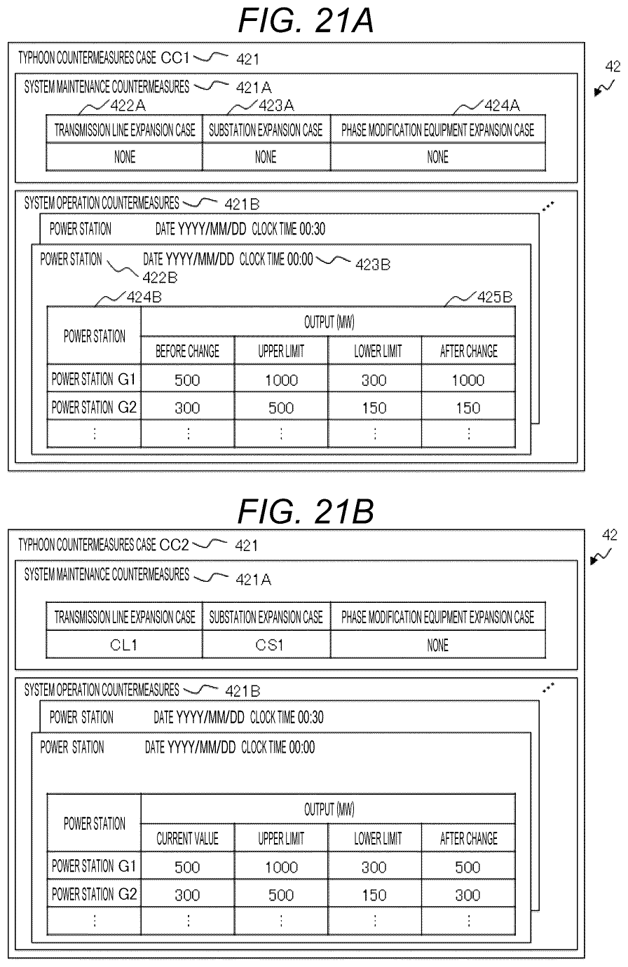

Next, the typhoon countermeasures candidate calculation result data 42 stored for each typhoon countermeasures case 421 and storing information on system maintenance countermeasures 421A and the system operation countermeasures 421B will be described with reference to FIGS. 21A and 21B.

The system maintenance countermeasures 421A of the typhoon countermeasures candidate calculation result data 42 whose typhoon countermeasures case 421 is CC1 illustrated in FIG. 21A stores information on a transmission line expansion case name 422A in a case where the system maintenance countermeasures type of the system maintenance countermeasures candidate data 32 is transmission line expansion, a substation expansion case name 423A in a case where the system maintenance countermeasures type is substation expansion, and a phase modification equipment expansion case name 424 in a case where the system maintenance countermeasures t phase modification equipment expansion.

The system operation countermeasures 421B of the typhoon countermeasures candidate calculation result data 42 illustrated in FIG. 21A stores, for each system operation countermeasures type 422B, the system operation countermeasures stored in the system operation countermeasures candidate data 33.

Specifically, in the case where the system operation countermeasures type 422B is operation change of the power station, the system operation countermeasures 421B store, for each date and time 423B, the power station name 424B and the information 425B on an output value before change, an output upper limit value, an output lower limit value, and an output value after change of the power station.

FIG. 21B is different from FIG. 21A in that the system maintenance countermeasures 421A of the typhoon countermeasures candidate calculation result data 42 whose typhoon countermeasures case 421 is CC2 illustrated in FIG. 21B store the system maintenance countermeasures candidate data 32 of the transmission line expansion case CL1 and the substation expansion case CS1.

Alternatively, the typhoon countermeasures candidate calculation result data 42 whose typhoon countermeasures case 421 is CC2 illustrated in FIG. 21B indicates that no operation change for system operation countermeasures (output after chafe of the power station is not changed from the current value).

Only the system operation countermeasures are performed as typhoon countermeasures in the typhoon countermeasures case CC1 (FIG. 21A), and only the system maintenance countermeasures are performed as typhoon countermeasures in the typhoon countermeasures case CC2 (FIG. 21B), but it goes without saying that both the system operation countermeasures and the system maintenance countermeasures may be performed as typhoon countermeasures.

The system maintenance countermeasures type may be other system maintenance countermeasures described in the description of the system maintenance countermeasures candidate data 32, and the system operation countermeasures type may be other system operation countermeasures described in the description of the system operation countermeasures candidate data 33.

As described above, the typhoon countermeasures candidate can be implemented. It is possible to quantitatively and accurately calculate the reliability economy index value (index value of reliability economy) for the typhoon countermeasures candidate.

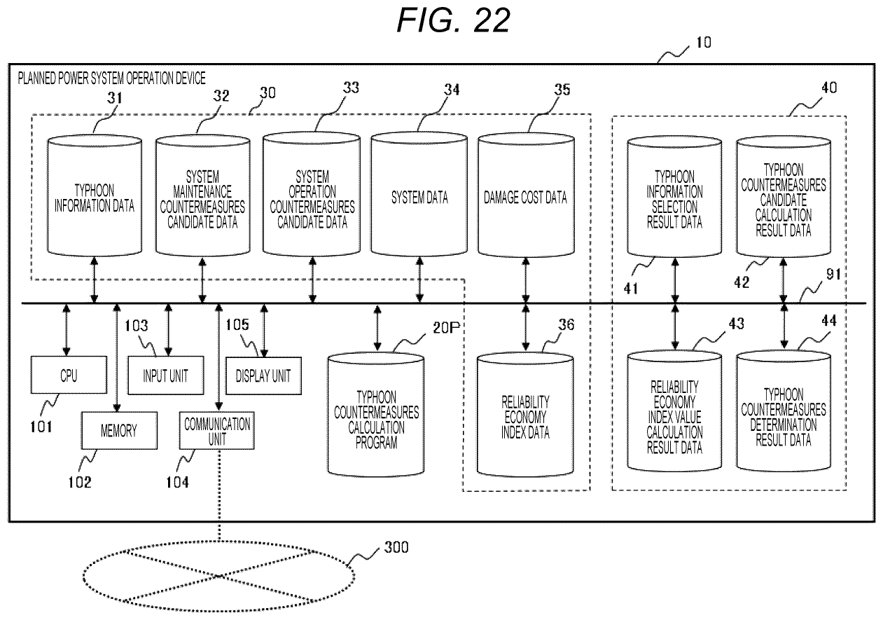

FIG. 22 is a view illustrating the hardware configuration of the planned power system operation device 10 of Example 3.

The planned power system operation device 10 of Example is different from the planned power system operation device 10 of FIG. 4 in that the typhoon countermeasures calculation input data DB 30 includes the system maintenance countermeasures candidate data 32 and is stored in the storage device as a database. Since the other configurations are the same as those in FIG. 4, the description thereof will be omitted.

### Example 4

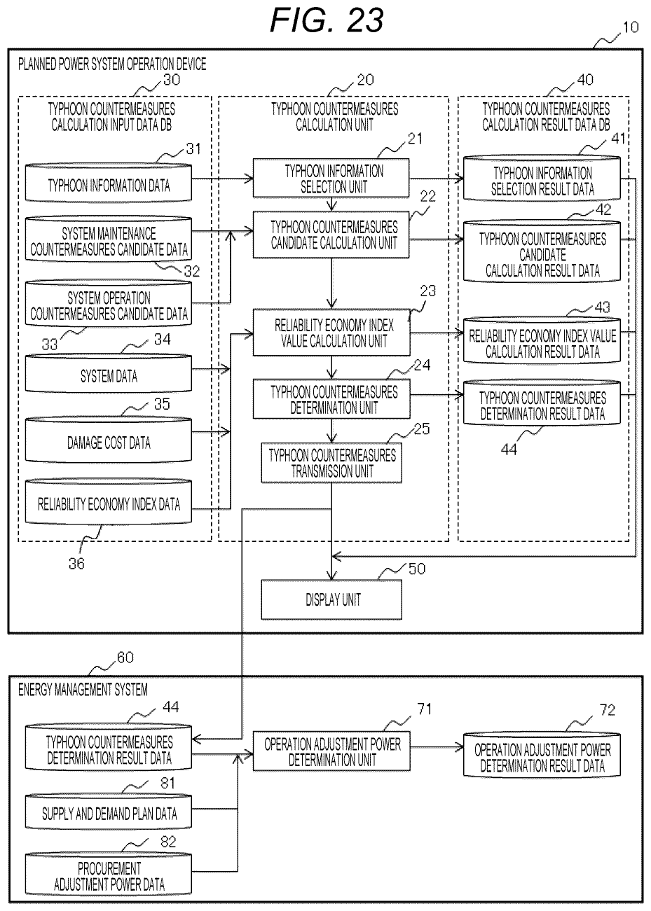

Next, an example in which the planned power system operation device 10 transmits the typhoon countermeasures determination result data 44 to the energy management system (EMS) and performs reduction in adjustment power operation cost and improvement in power resilience in the energy management system will be described with reference to FIG. 23.

FIG. 23 is a view illustrating the functional configuration of the planned power system operation device 10 in Example 4 and the functional configuration of the energy management system 60.

The planned power system operation device 10 of FIG. 23 is different from the planned power system operation device 10 of FIG. 2 of FIG. 19 in adding the typhoon countermeasures transmission unit 25 that transmits, to the energy management system 60, the typhoon countermeasures determination result data 44 determined by the typhoon countermeasures determination unit 24. Since other configurations of the planned power system operation device 10 are similar to those of FIG. 2, the description thereof is omitted here. Since the energy management system 60 is the same as the energy management system 60 described with reference to FIG. 17, the description thereof is omitted here.

According to Example 4, in addition to suppression of supply and demand and frequency fluctuation with respect to imbalance between the power generation and the demand, it is possible to operate the adjustment power that can perform both reduction in adjustment power operation cost and improvement in power resilience.

### Example 5

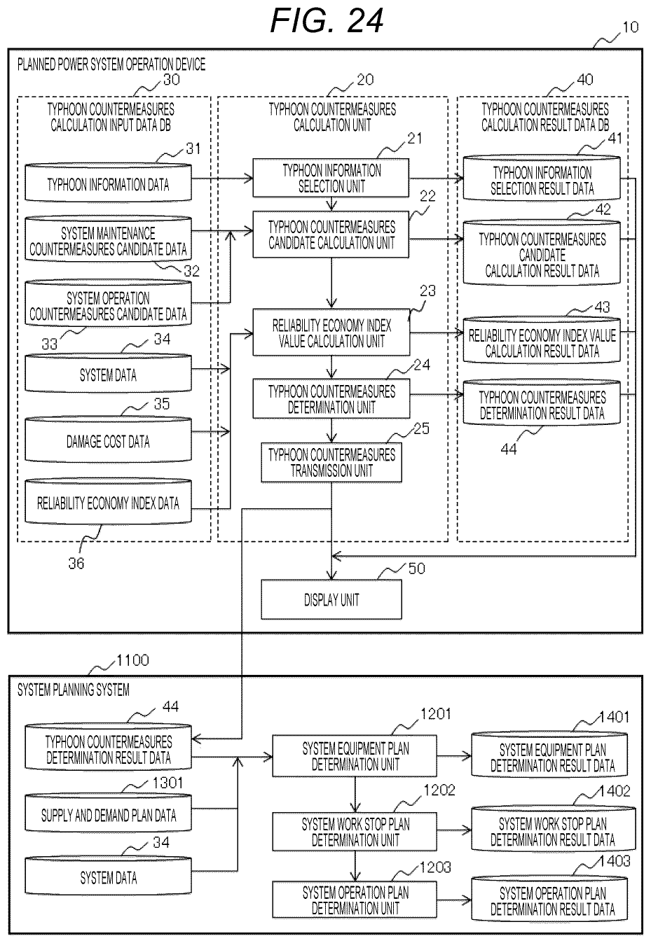

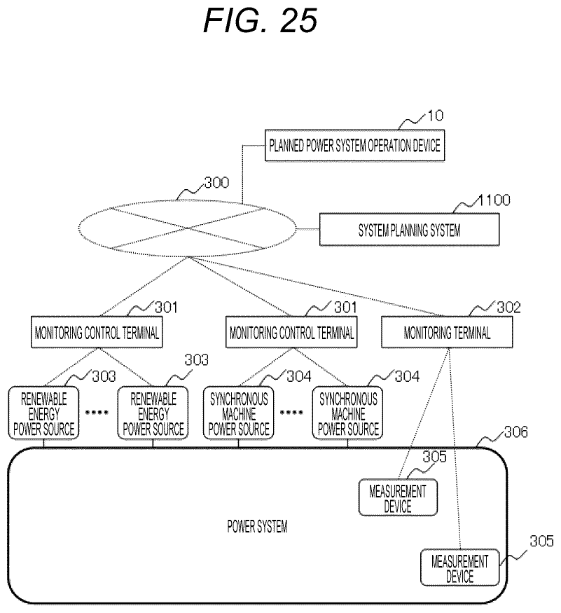

Next, an example in which the planned power system operation device 10 transmits the typhoon countermeasures determination result data 44 to the system planning system, and performs reduction of a system plan cost and improvement in power resilience in the system planning system will be described with reference to FIGS. 24 and 25.

FIG. 24 is a view illustrating the functional configuration of the planned power system operation device 10 in Example 5 and the functional configuration of the system planning system 1100.

The planned power system operation device 10 of FIG. 24 is different from the planned power system operation device 10 of FIG. 19 in adding the typhoon countermeasures transmission unit 25 that transmits, to the system planning system 1100, the typhoon countermeasures determination result data 44 determined by the typhoon countermeasures determination unit 24. Since other configurations of the planned power system operation device 10 are similar to those of FIG. 19, the description thereof is omitted here.

The system planning system 1100 includes a database that stores the typhoon countermeasures determination result data 44, supply and demand plan data 1301, and the system data 34, a system equipment plan determination unit 1201, a system work stop plan determination unit 1202, a system operation plan determination unit 1203, and a database that stores system equipment plan determination result data 1401, system work stop plan determination result data 1402, and system operation plan determination result data 1403.

The typhoon countermeasures determination result data 44 is information transmitted from the typhoon countermeasures transmission unit 25 of the planned power system operation device 10.

The supply and demand plan data 1301 is information regarding a power generation plan and a supply and demand plan provided from a power generation operator and a retailer to a general power transmission/distribution operator.

The system data 34 is a system configuration, a line impedance (R+jX), a ground capacitance (susceptance: jB), data necessary for system configuration and state estimations (such as a threshold of bat data), generator data, and data necessary for other power flow calculation, state estimation, and time series change calculation.

The system equipment plan determination result data 1401 is information regarding the determination result of the equipment the system maintenance plan regarding countermeasures described in the system maintenance countermeasures candidate data 32.

The system work stop plan determination result data 1402 is information regarding the determination result of the work stop plan of the equipment regarding the system maintenance countermeasures.

The system operation plan determination result data 1403 is information regarding the determination result of the operation plan of the equipment regarding the system maintenance countermeasures.

Using the typhoon countermeasures determination result data 44, the supply and demand plan data 81, and the system data 34, the system equipment plan determination unit 1201 determines the equipment plan regarding the system maintenance countermeasure as in the description of the system maintenance countermeasures candidate data 32, and outputs the system equipment plan determination result data 1401. The determination method of the equipment plan obtains, for example, an equipment plan that can maintain system stability and has low equipment expansion cost described in the N−1 contingency and the reliability economy index value calculation result data 43. Note that the determination method of the equipment plan may be a method other than the above.

Using the system equipment plan determination result data 1401, the system work stop plan determination unit 1202 determines a work stop plan of the equipment regarding system maintenance countermeasures, and outputs the system work stop plan determination result data 1402. The determination method of the work stop plan obtains, for example, a work stop plan that can maintain system stability and has low work stop cost described in the N−1 contingency and the reliability economy index value calculation result data 43. Note that the determination method of the work stop plan may be a method other than the above.

Using the system work stop plan determination result data 1402, the system operation plan determination unit 1203 determines the operation plan of the equipment regarding system maintenance countermeasures, and outputs the system operation plan determination result data 1403. The determination method of the operation plan obtains, for example, an operation plan that can maintain system stability and has low operation cost described in the N−1 contingency and the reliability economy index value calculation result data 43. Note that the determination method of the operation plan may be a method other than the above.

In this manner, it is possible to perform a system plan that can achieve both reduction in system maintenance cost and improvement in power resilience in addition to maintenance of the N−1 contingency and system stability.

FIG. 25 is a view illustrating the planned power system operation system of Example 5 applied with the planned power system operation device 10 and the system planning system 1100 described in FIG. 24.

The planned power system operation system of FIG. 25 is different from the planned power system operation system of FIG. 18 in that the energy management system 60 of the planned power system operation system of FIG. 18 is replaced with the system planning system 1100 connected to the planned power system operation device 10 via the network 300.

In the present example, the planned power system operation device 10 can transmit and receive data via the system planning system 1100 and the network 300, but the planned power system operation device 10 may be an internal device of the system planning system 1100 and transmit and receive data via an internal communication network.

In the present example, an example in which the transmission destination of the typhoon countermeasures determination result data 44 is the system planning system 1100 has been described, but the transmission destination may be other systems such as a system stabilization system, a core management system, a system management system, and a market management system.

The present invention is not limited to the examples described above, and includes various modifications. The above examples have been described in detail for easy understanding in the present invention, and are not necessarily limited to those having all the described configurations. It is possible to replace a part of the configuration of a certain embodiment with the configuration of another embodiment, and it is also possible to add the configuration of another embodiment to the configuration of a certain embodiment.

### REFERENCE SIGNS LIST

10 Planned power system operation device
20 Typhoon countermeasures calculation unit
21 Typhoon information selection unit
22 Typhoon countermeasures candidate calculation unit
23 Reliability economy index value calculation unit
24 Typhoon countermeasures determination unit
25 Typhoon countermeasures transmission unit
30 Typhoon countermeasures calculation input data DB
31 Typhoon information data
32 System maintenance countermeasures candidate data
33 System operation countermeasures candidate data
34 System data
35 Damage cost data
36 Reliability economy index data
40 Typhoon countermeasures calculation result data DB
41 Typhoon information selection result data
42 Typhoon countermeasures candidate calculation result data
43 Reliability economy index value calculation result data
44 Typhoon countermeasures determination result data
50 Display control unit
60 Energy management system
435 Index value of reliability economy
1100 System planning system

1. A planned power system operation device, comprising:
a typhoon countermeasures candidate calculation unit that obtains typhoon countermeasures candidate calculation result data including a change value of an output of a power station for each typhoon countermeasures case from typhoon information data including at least course information and wind speed of a typhoon and system operation countermeasures candidate data including output information of a power station;
a reliability economy index value calculation unit that obtains reliability economy index value calculation result data, which is an index value of reliability economy, from the typhoon countermeasures candidate calculation result data, system data indicating a system configuration, damage cost data associated with a power outage, and reliability economy index data indicating a weight on an influence of a power outage; and
a typhoon countermeasures determination unit that obtains typhoon countermeasures determination result data from the reliability economy index value calculation result data.

2. The planned power system operation device according to claim 1, wherein
the typhoon information data includes course information and wind speed of a past typhoon.

3. The planned power system operation device according to claim 1, wherein
using a probability distribution function indicating a relationship between a wind speed and a collapse rate of a transmission tower, the typhoon countermeasures candidate calculation unit obtains a cutoff rate of a transmission line from a collapse rate of a transmission tower by a typhoon, and obtains the typhoon countermeasures candidate calculation result data including a change value of an output of a power station.

4. The planned power system operation device according to claim 1, wherein
the system operation countermeasures candidate data includes a system operation countermeasure of at least any one of an output change of a power station, a power station start and stop, a substation tap change, on and off of a phase modification equipment, and on and off of a transmission line, and an operation cost of the system operation countermeasure.

5. The planned power system operation device according to claim 1, wherein
the damage cost data is at least one of a power outage cost for each substation, a power outage cost for each consumer, and a power outage cost for each consumer type.

6. The planned power system operation device according to claim 1, wherein
the reliability economy index data indicates a weight of each of a countermeasures cost and a damage cost expected value.

7. The planned power system operation device according to claim 1, wherein
the typhoon countermeasures candidate calculation result data includes at least any of expansion details for system maintenance countermeasures and operation change details for system operation countermeasures.

8. The planned power system operation device according to claim 1, wherein
the reliability economy index value calculation result data includes the typhoon countermeasures case, a countermeasures cost of the typhoon countermeasures case for the typhoon countermeasures case, and a damage cost expected value and an index value of reliability economy in the typhoon countermeasures case.

9. The planned power system operation device according to claim 1, wherein
the typhoon countermeasures determination unit determines, as a selection result of typhoon countermeasures, a typhoon countermeasures case having a minimum sum of index values of reliability economy in the typhoon countermeasures case.

10. The planned power system operation device according to claim 1, comprising:
a typhoon countermeasures transmission unit that transmits typhoon countermeasures determination result data obtained by the planned power system operation device to any of an energy management system, a system planning system, a system stabilization system, a core management system, a system management system, and a market management system.

11. The planned power system operation device according to claim 1, wherein
the planned power system operation device is an internal device of any system of an energy management system, a system planning system, a system stabilization system, a core management system, a system management system, and a market management system.

12. A planned power system operation method of a power system, the planned power system operation method comprising:
a typhoon countermeasures candidate calculation step of obtaining countermeasures candidate calculation result data for each typhoon countermeasures case from typhoon information data including at least course information and wind speed of a typhoon, system operation countermeasures candidate data, and system maintenance countermeasures candidate data;
a reliability economy index value calculation step of obtaining reliability economy index calculation result data, which is an index value of reliability economy, from the countermeasures candidate calculation result data, system data indicating a system configuration, damage cost data associated with a power outage, and reliability economy index data indicating a weight on an influence of a power outage; and
a typhoon countermeasures determination step of obtaining the typhoon countermeasures determination result data from the reliability economy index calculation result data.

13. The planned power system operation method according to claim 12, wherein
the system maintenance countermeasures candidate data includes any one or more system maintenance countermeasures of transmission line expansion, substation expansion, phase modification equipment expansion, high voltage direct current equipment expansion, synchronous phase modification machine expansion, static var compensator expansion, self-excited SVC expansion, SVG expansion, STATCOM expansion, and phase shifter expansion, and an expansion cost of the system maintenance countermeasures.
